(19) United States
(12) Patent Application Publication
(10) Pub. No.: US 2012/0079549 A1
(43) Pub. Date: Mar. 29, 2012

(54) METHODS, APPARATUSES AND COMPUTER PROGRAM PRODUCTS FOR MEDIA RECORDING

(76) Inventor: René Dekker, Stockholm (SE)

(21) Appl. No.: 13/319,574

(22) PCT Filed: May 29, 2009
(86) PCT No.: PCT/SE2009/050628

§ 371 Date: Nov. 9, 2011

(51) Int. Cl. H04N 21/231

(52) U.S. Cl. 725/115

(57) ABSTRACT

It is presented a media caching apparatus for caching media content for a plurality of remotely located recording devices, where each remotely located recording device is connectable to the media caching apparatus via a respective local access line. The media caching apparatus comprises: a controller for receiving cache commands to temporarily store a specified media content; a memory for temporarily storing media content and to store an association between the specified media content and the specified recording device; a content receiving interface for receiving the specified media content and store the media content in the memory; and a content transmitting interface for sending the specified media content to the specified recording device via the local access line coupled to the specified recording device, wherein the content transmitting interface prevents affecting delivery of higher priority content on the local access line coupled to the specified recording device.

### TECHNICAL FIELD

The invention relates generally to digital media networks, and more particularly to improved media recording in digital media networks.

### BACKGROUND

Within digital media networks, such as IPTV (Internet Protocol Television), there are two main types of content recording. The first one is network personal video recording (NPVR) and the second one is local personal video recording (LPVR).

With NPVR, the recording of the content is made in the network. That is, when content, e.g. television content, is to be recorded, a device in the network receives the content and records the content. At the moment the user wants to playback the recording, a dedicated streaming connection is set up between the end user device and the network recording device. The network device records only those programs that are requested to be recorded, or it may simply record the whole television channel.

In LPVR, the recordings are effected at a local device in the user's home (or other premises), typically using a set top box (STB) which can also be used for live television viewing. When a recording is to be made, the local device initiates a network connection to receive the television channel (it “joins” the channel). The channel content is then streamed in real-time to the local device where it is recorded. When the user plays back the recording, it is played from the local device, without network interaction. An implication of using an LPVR is that when recording, the channel needs to be streamed to the local device recorder, which uses up bandwidth of the local access line to the home. This reduces the number of channels that the end user can watch when a recording is active. For example, if the local access line only has a capacity of two channels, there is only enough bandwidth for the user to watch one other channel than the one that is being recorded, which is a problem if there are multiple television sets in the home.

NPVR has the advantage that content can be recorded without, at the time of recording, using the local access line to the end user. In other words, content can be recorded in the network without limiting the number of simultaneous channels that can be watched at the premises of the end user. Often it is the link closes to the user equipment, between the user equipment and the network access node, commonly denoted the local access line, which presents the largest bandwidth issues, whereby the NPVR solutions presents a utilisation advantage over LPVR.

However, one issue with the NPVR solution is a psychological one. Users are more comfortable with the knowledge that the content is recording on their own device in their own home, than at a device in the network outside their control. Additionally, NPVR requires recording capacity in the network, and it is not possible to play back the recording if the network is faulty. Furthermore, in some countries, such as USA, there are possible legal limitations on what can be recorded in the network.

There is thus a clear need to improve the recording possibilities while preventing any negative effects on user bandwidth utilisation.

### SUMMARY

An object of the invention is to provide network based recording while still allowing the user to be in control over the content.

A first aspect of the invention is a media caching apparatus for caching media content for a plurality of remotely located recording devices, where each remotely located recording device is connectable to the media caching apparatus via a respective local access line. The media caching apparatus comprises: a controller configured to receive cache commands to temporarily store a specified media content for a specified recording device; a memory configured to temporarily store media content and to store an association between the specified media content and the specified recording device; a content receiving interface configured to receive the specified media content and store the media content in the memory; and a content transmitting interface configured to send the specified media content to the specified recording device via the local access line coupled to the specified recording device, wherein the content transmitting interface prevents affecting delivery of higher priority content on the local access line coupled to the specified recording device.

Using the solution presented here, the bandwidth problems related to local PVR and limited bandwidth local access lines are circumvented. The solution allows that a capacity of little more than a single stream per television set is sufficient for supporting content on local recording devices. At the same time, it maintains all the benefits of a local PVR solution while avoiding the NPVR problems, e.g. of user scepticism and lack of end-user control.

The memory may be configured to store a plurality of associations between the specified media content and a plurality of specified recording devices, in response to receiving a plurality of cache commands to temporarily store the specified media content, wherein each cache command specifies a different recording device; and the content transmitting interface may be configured to send the media content to all of the plurality of recording devices.

The media caching apparatus may further comprise a content manager configured to delete the media content from the memory when the media content has been transmitted to all specified recording devices.

The content receiving interface may be configured to receive the specified media content from television content.

The media content may comprise video and audio content. or the media content may comprise audio content.

The content transmitting interface may be configured to prevent affecting delivery of higher priority content by sending the specified media content at a lower priority than that at which higher priority content is transmitted.

The content transmitting interface may be configured to prevent affecting delivery of higher priority content by limiting the rate at which the media content is sent according to commands from a resource allocation apparatus.

The content transmitting interface may be configured to send media content only when the media caching apparatus has received a command from the specified recording device that a data portion of the media content can be sent.

A second aspect of the invention is a method for caching media in a media caching apparatus for a remotely located recording device, the remotely located recording device being connected to the media caching apparatus via a local access line. The method comprises the steps, performed in the media caching apparatus, of: receiving a cache command to temporarily store a specified media content for a specified recording device; storing an association between the specified media content and the specified recording device; receiving the media content; storing the media content in a memory; and sending the media content via a transmission line to the specified recording device via the local access line coupled to the specified recording device, while preventing affecting delivery of higher priority content on the local access line coupled to the specified recording device.

The steps of receiving the media content, storing the media content and sending the media content may be performed in parallel.

The step of receiving a cache command may comprise receiving a plurality of cache commands to temporarily store the specified media content, wherein each cache command specifies a different recording device; the step of storing an association may comprise storing a plurality of associations between the specified media content and a plurality of specified recording devices; and the step of sending the media content may comprise sending the media content to all of the plurality of recording devices.

The method may further comprise the step of deleting the media content from the memory when the media content has been transmitted to all specified recording devices.

The step of receiving the media content may comprise receiving the specified media content from broadcast television content.

The media content may comprise video and audio content.

The step of sending the media content may prevent affecting delivery of higher priority content by sending the media content at a lower priority than that at which higher priority content is transmitted.

The step of sending the media content may prevent affecting delivery of higher priority content by limiting the rate at which the media content is sent according to commands from a resource allocation apparatus.

The step of sending the media content can be such that it only sends media content when a command has been received from the specified recording device that a data portion of the media content can be sent.

A third aspect of the invention is a computer program for caching media in a media caching apparatus for a remotely located recording device, the remotely located recording device being connected to the media caching apparatus via a local access line. The computer program comprises computer program code which, when run on the media caching apparatus, causes the media caching apparatus to: receive a cache command to temporarily store a specified media content for a specified recording device; store an association between the specified media content and the specified recording device; receive the media content; store the media content in a memory; and send the media content via a transmission line to the specified recording device via the local access line coupled to the specified recording device, while preventing affecting delivery of higher priority content on the local access line coupled to the specified recording device.

A fourth aspect of the invention is a computer program product comprising a computer program according to the third aspect and a computer readable means on which the computer program is stored.

A fifth aspect of the invention is a media recording device being connectable to a remotely located media caching apparatus via a local access line. The media recording device comprises: a controller configured to send a cache command to a caching apparatus to temporarily store a specified media content for the recording device; a memory configured to store media content; and a content receiving interface configured to receive the specified media content and store the media content in the memory.

The media recording device may be comprised in a set top box, a television set, a personal computer, a media player or a game console.

The controller may be configured to send a cache command to the media caching apparatus to send a data portion of the media content when the controller determines the local access line to have sufficient free capacity for the data portion.

A sixth aspect of the invention is a method, performed in a media recording device which is connected to a remotely located media caching apparatus via a local access line. The method comprises the steps of: sending a cache command to a caching apparatus to temporarily store a specified media content for the recording device; and receiving the specified media content and storing the media content in a memory.

A seventh aspect of the invention is a computer program for a media recording device connected to a remotely located media caching apparatus via a local access line. The computer program comprises computer program code which, when run on the media recording device, causes the media recording device to: send a cache command to a caching apparatus to temporarily store a specified media content for the recording device; and receive the specified media content and storing the media content in a memory.

An eighth aspect of the invention is a computer program product comprising a computer program according to the seventh aspect and a computer readable means on which the computer program is stored.

It is to be noted that any feature of the first, second, third and fourth aspects may, where appropriate, be applied to any other of these aspects. Furthermore any feature of the fifth, sixth, seventh and eighth aspects may, where appropriate, be applied to any other of these aspects.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram showing an overview of an Internet protocol television (IPTV) environment where an embodiment of the invention can be applied;

FIG. 2 is a schematic diagram showing components of an embodiment of the media caching apparatus of FIG. 1 and interfacing entities;

FIG. 3 shows one example of a computer program product comprising computer readable means;

FIG. 4 is a schematic diagram showing components of an embodiment of the media recording device of FIG. 1 and interfacing entities;

FIG. 5 is a flow chart illustrating a method performed in the media caching apparatus of FIG. 1;

FIG. 6 is a flow chart illustrating a method performed in the recording device of FIG. 1; and

FIG. 7 is a sequence diagram illustrating the interaction of some of the components of FIG. 1 for the caching apparatus to cache content for the recording device.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

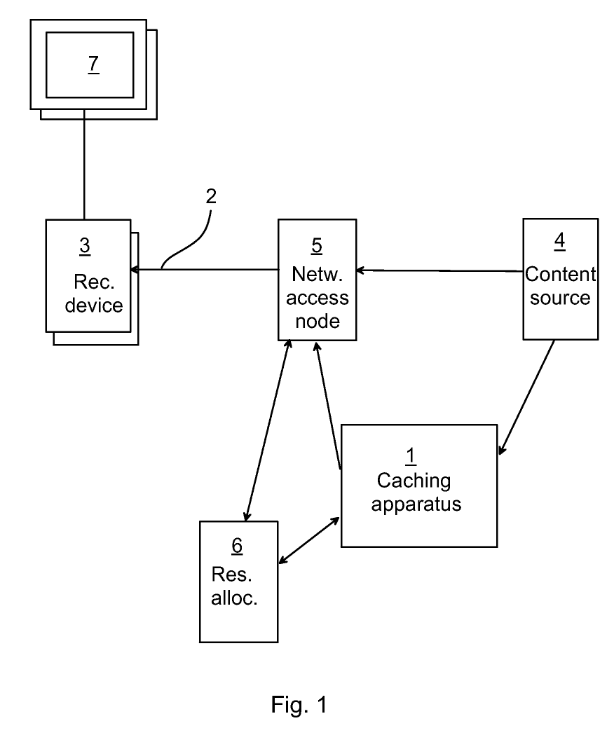

FIG. 1 is a schematic diagram showing an overview of an Internet protocol television (IPTV) environment where an embodiment of the invention can be applied. During live television viewing, the content from the content source 4 is distributed via a network access node 5 to a set top box or other receiver such that the content can be displayed on the display 7, such as a television set. A recording device 3 is provided which can record content for later viewing. The connection between the home, which holds the display 7 and the recording device 3, and the network access node 5 is called the local access line 2 and is often a bandwidth bottleneck in an IPTV system.

The recording device 3 can be a separate device, or it can be integrated in a set top box or the display 7. Alternatively, the recording device 3 can be implemented using a general purpose computer, such as a personal computer, or a more media related device such as a media player or even a game console. The display 7 can be a television with integrated digital tuner or digital tuning capabilities can be provided externally.

In the embodiment, a media caching apparatus 1 is provided for temporary storage of media content. As will be explained in further detail below, the media caching apparatus 1 caches content from the content source 4 destined for one or more recording devices 3. Using the media caching apparatus 1, the bandwidth of content delivered to the one or more recording devices 3 can be controlled such that only an acceptable amount of bandwidth is used on the local access line 2. The total bandwidth that is available on a line to each subscriber is limited, whereby by limiting the bandwidth for the recording device 3, higher priority traffic is completely or essentially unaffected by the delivery of content from the media caching apparatus 1 to the recording device 3.

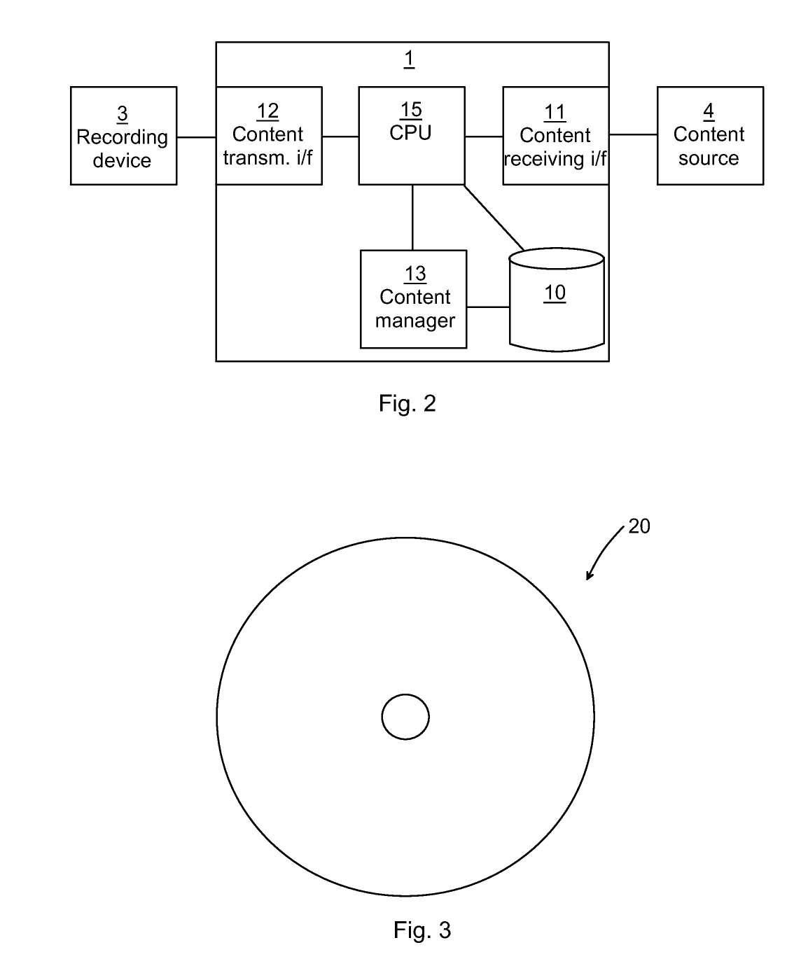

Recordings can be scheduled by either the end-user or the operator by sending a cache command with an identifier of a media content to be cached by the media caching apparatus 1, as well as an identifier of the destination recording device 3. When the recording starts the media caching apparatus 1 will arrange to receive the television stream from the content source 4, such as a television head-end (for example, by sending an JOIN request according to the Internet Group Management Protocol, IGMP). This will cause the network to route the television stream to the media caching apparatus 1. The media caching apparatus 1 will then start recording the content of the stream in a storage memory under its control (memory 10 of FIG. 2).

In parallel, the recording device 3 will start to download the recorded content from the media caching apparatus 1, and store it on its local storage. At that time, the maximum speed possible for content download is the real-time speed as sent by the television head-end. However, when insufficient bandwidth is available on the local access line 2, the download speed will be lower than real-time speed. This situation will typically occur if more streams are received in the same building as the recording device. e.g. live viewing or recording of other television channels.

Hence, care must be taken that the content which is downloaded from the media caching apparatus 1 to the recording device 3 does not affect other content that may be streamed directly to the home, for example a live television stream the user is watching at that moment. At least three mechanisms can be used to achieve that goal:

The first mechanism is to classify the downloaded content traffic from the media caching apparatus 1 to the recording device 3 as “best effort” traffic in the network. The network routing mechanisms will make sure that any live content feeds will take priority over the downloaded content. When TCP is used as transfer protocol, the TCP resend and back-off mechanisms will then automatically lower the transfer speed of the download.

The second mechanism is to deploy an active resource allocation device 6 that keeps track of the capacity of each local access line 2 and the amount of bandwidth used by all active streams on it, whereby it assigns bandwidth allocations accordingly. With the help of the resource allocation device 6, the media caching apparatus 1 can determine exactly how much bandwidth can be used by the downloaded content.

The third mechanism is to let the recording device 3 be responsible for how much bandwidth is used for the download from the media caching apparatus 1 to the recording device 3. The recording device 3 (or other entity in the same locality, using the same local access line 2) is then responsible to determine how much bandwidth is used on the local access line 2, and using a known value of maximum bandwidth, the recording device can calculate how much available bandwidth can be used to download content from the media caching apparatus 1. Using the available bandwidth value, the recording device 3 can send commands to the media caching apparatus 1 for each data packet to be sent. Alternatively, the recording device can send a command to the media caching apparatus 1 with a bandwidth not to exceed for a particular download.

Due to the limited bandwidth capacity available on the local access line 2, the recording of the content on the recording device 3 will typically complete at some point in time after the broadcast of the recorded content has finished. After the content has fully arrived on the recording device 3, it may be deleted from the media caching apparatus 1. Alternatively, the same content, e.g. the same television programme, can be used for a plurality of recording devices. Each recording device being interested in the particular piece of content then sends a cache command to the media caching apparatus 1 and the media caching apparatus 1 then keeps track of when the content has been downloaded and to what recording device 3. When the media content has been downloaded by all recording devices 3 that had sent cache commands, the content can be safely deleted.

When the user wants to playback the recording after it has fully arrived on the recording device 3, the user can simply play the content from the local device. When the content has not, or not fully arrived at playback time, it is still presented to the user as if the content is available locally.

In that case one of two approaches for concurrent playback can be taken:

In the first concurrent playback approach, the playback starts from the locally recorded content. It is made sure that enough bandwidth is available on the local access line 2 to cater for the playback speed. In other words, the download speed must be the same as, or greater than, the playback speed. This can be achieved by removing an existing television stream to release capacity for the download. Typically, this is not an issue, because the local access line 2 is dimensioned for at least one stream per television, and the user is not watching two streams in parallel on the same device.

However, in this case, measures must be taken to make sure the download stream is not disturbed by other best effort traffic, e.g. regular Internet traffic over the same local access line 2. This can be done by giving the download content its own priority. For example, the download content can be given a priority which is higher than regular Internet traffic but lower than live television content.

In the second approach for concurrent playback, the recording device 3 sets up a direct stream from the media caching apparatus 1, bypassing the local storage. This stream will be bandwidth prioritised in the same way as any other direct stream from the network—either by prioritising the stream over best effort traffic, and/or by ensuring bandwidth allocation through the resource allocation device 6 or the recording device 3. The download to the local storage will thus continue in parallel with reduced transfer speed.

The system of FIG. 1 thus ensures that the capacity for a single stream per television set 7 is sufficient for supporting local PVR. At the same time, it maintains all the benefits of the local storage of a local PVR solution while avoiding the NPVR problems such as user scepticism.

Another advantage is the circumvention of the possible legal limitations of NPVR recordings in some countries. This is achieved in two ways. Firstly, the temporary storage in the network just caches for the recording device 3, and therefore legal limitations for NPVR should not apply to it. Secondly, even if the temporary storage were to be considered an NPVR recording, the download from the media caching apparatus 1 to the recording device 3 could be considered playback in that sense, and because it starts before the program is finished, it should fall under time-shifted television regulations.

As a side effect of this, the bandwidth reservation problems surrounding IPTV are also simplified. Because the presented solution only requires one stream per television set to be supported in many different scenarios of recording and viewing, the need for a dynamic bandwidth reservation is greatly reduced. It is possible to statically reserve the bandwidth for just one stream per television set, and have all other traffic set as best effort in the network.

FIG. 2 shows modules 10-15 of an embodiment of the media caching apparatus 1 of FIG. 1 and interfacing entities. The various modules 10-15 can be implemented by means of software and/or hardware. It is also to be noted that the modules may share some hardware components such as controllers and memory 10. A controller 15 is provided using any suitable central processing unit (CPU), microcontroller, digital signal processor (DSP), etc., capable of executing software instructions stored in a memory 10. The memory 10 can be any combination of read and write memory (RAM) and read only memory (ROM). The memory 10 also comprises persistent storage, e.g. for storing the media content. The persistent memory can be any single one or combination of magnetic memory, optical memory, or solid state memory.

Optionally, a user interface is provided (not shown) for operator usage. Alternatively, the server can be operated remotely or locally using a network interface. A timer (not shown), as known in the art per se, is provided to allow cache recordings to start at a specified time. A content receiving interface 11 receives content from the content source 4 of FIG. 1. A content transmitting interface 12 sends content to one or more recording devices 3.

The media caching apparatus 1 can be integrated in one unit, or it can be separated into several separate units, e.g. for reasons of upgradeability, ease of implementation or redundancy. In the case that there are several units that make up the media caching apparatus 1, some units may be present in more than one unit, such as the controller 15 and the storage 10.

FIG. 3 shows one example of a computer program product comprising computer readable means 20. On this computer readable means 20, a computer program can be stored, which computer program can cause a computer to execute the method according to embodiments described herein. In this example, the computer program product is an optical disc, such as a CD (compact disc), a DVD (digital versatile disc) or a blu-ray disc. The computer readable means can also be solid state memory, such as flash memory or a software package distributed over a network, such as the Internet. The computer readable means can hold a computer program for methods for the media caching apparatus 1 and/or the recording device 3.

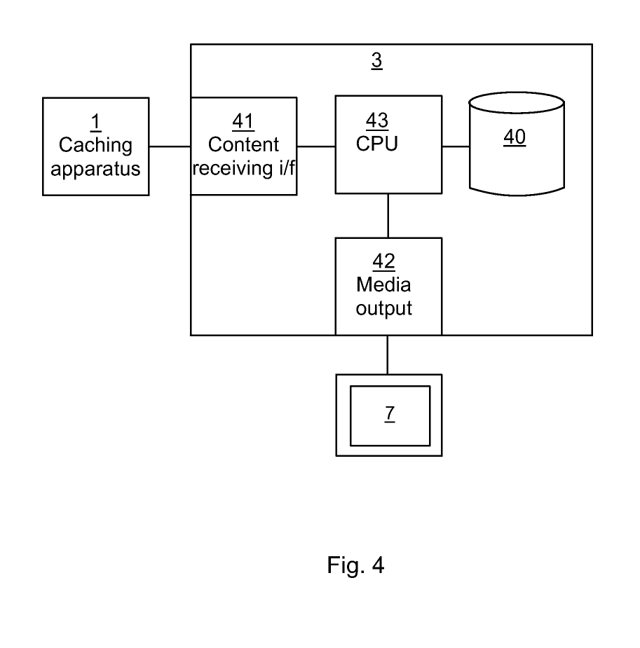

FIG. 4 shows modules 40-43 of an embodiment of the recording device 3 of FIG. 1 and interfacing entities. The various modules 40-43 can be implemented by means of software and/or hardware. It is also to be noted that the modules may share some hardware components such as controllers and memory. A controller 43 is provided using any suitable central processing unit (CPU), microcontroller, digital signal processor (DSP), etc., capable of executing software instructions stored in a memory 40. The memory 40 can be any combination of read and write memory (RAM) and read only memory (ROM). The memory 40 also comprises persistent storage, e.g. for storing the media content. The persistent memory can be any single one or combination of magnetic memory, optical memory, or solid state memory. A content receiving interface 41 receives content from the media caching apparatus 1. Optionally, the content receiving interface 41 can also receive content directly from the content source 4. A media output module 42 outputs media, e.g. to the display 7 to allow the end user to view the content.

The recording device 3 can be a separate entity or it can be integrated in a set top box for digital content viewing or in a television 7. Moreover, the recording device can be separated into multiple units, e.g. by separating persistent storage of the memory 40 from the rest of the recording device 3. The user controls the recording device either directly, e.g. using a remote control, or via a secondary device, such as television 7, which secondary device then sends and receives commands to/from the recording device 3.

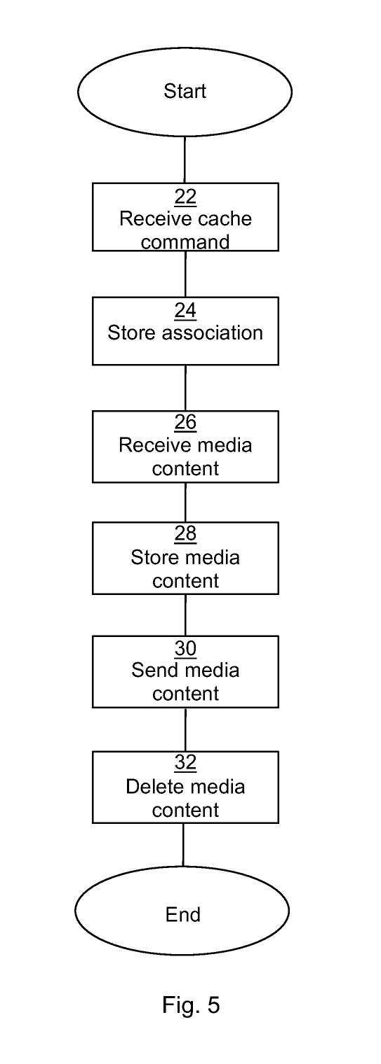

FIG. 5 is a flow chart illustrating a method performed in the media caching apparatus of FIG. 1.

In an initial receive cache command step 22, a command is received to temporarily store a specified media content for a specified recording device (3). The cache command can be received in advance, where the cache command then specifies a start time, an end time and a content source. For example, the command can specify to cache television channel X from 20:00 to 21:00. This command is typically received from the same recording device 3 which will also eventually download the specified media content.

The cache command and association between the specified media content and the specified recording device is stored in memory 10 in a store association step 24.

The steps of receiving cache commands and storing the associations can be executed in a separate process in the media caching apparatus 1, largely unaffected by other processing in the media caching apparatus 1, e.g. content transfer. Moreover, the media caching apparatus 1 typically receives a large number of cache commands and will manage parallel content caching as required.

Since the media caching apparatus 1 is located in the network with high bandwidth connections with the content source, multiple sources can be cached simultaneously in real-time.

In a receive media content step 26, the specified media content is received from the content source 4 and is stored in the memory 10 in a store media content step 28.

The specified media content can then be transmitted to the recording device/devices 3 in the send media content step 30. The transmission occurs via the local access line 2 which is coupled to the specified recording device 3. At the same time, the media caching apparatus 1 prevents affecting delivery of higher priority content on the same local access line 2 as explained above, e.g. using priorities or active bandwidth management.

The steps 26, 28, 30 of receiving media content, storing media content and sending media content can be executed in parallel.

Once the media has been downloaded by all recording devices 3 that requested the caching for the specified content, the specified media content is deleted in the delete media content step 32.

The above described method can be executed as software instructions in a server, such as the media caching apparatus 1.

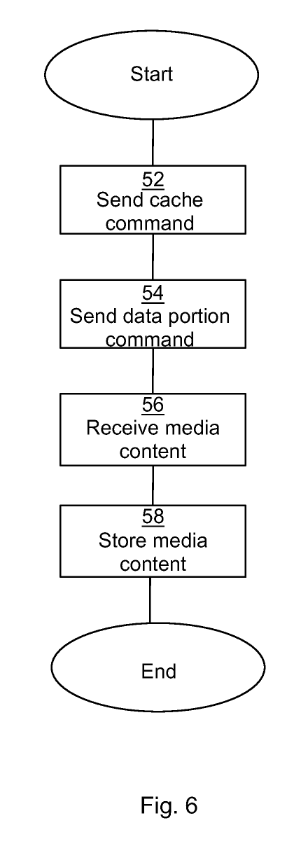

FIG. 6 is a flow chart illustrating a method in the recording device 3, where the method of FIG. 6 is arranged to interact with the method illustrated by the flow chart of FIG. 5.

In an initial send cache command step 52, the recording device 3 sends a command to the media caching apparatus 1 to cache a particularly defined piece of media content.

The optional send data portion command step 54, is only executed in the “pull” case, i.e. when the recording device is responsible for bandwidth management for the download. Here, the recording device 3 sends a command to the media caching apparatus 1 to send a data packet to the recording device, effecting a small part of the download from the media caching apparatus 1 to the recording device.

The specified media content is subsequently received from the media caching apparatus 1 in a receive media content step 56 and the specified media content is stored in a store media content step 58.

The steps 56, 58 of receiving and storing the specified media content are typically repeated until the entire specified media content has been downloaded.

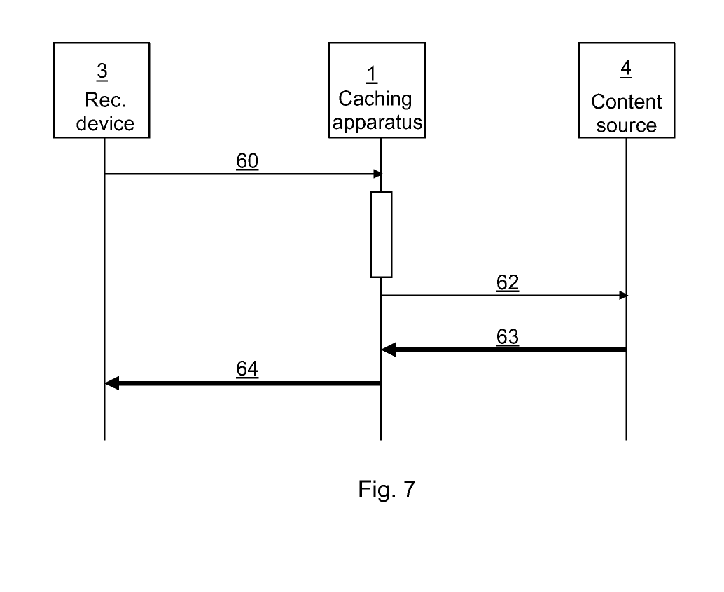

FIG. 7 is a sequence diagram illustrating the interaction of some of the components of FIG. 1 for the caching apparatus to cache content for the recording device. It is the communication between the recording device 3, the caching apparatus 1 and the content source 4 that is illustrated here.

First the recording device sends 60 a caching command comprising a content identifier and a recording device identifier (i.e. itself) to the caching apparatus 1. The content identifier includes a start time, stop time and a content source, e.g. a channel.

The caching apparatus 1 stores the data of the caching command and, using the timer of the caching apparatus 1, the caching apparatus then sends 62 a join command, or equivalent, in order for the content source to start sending 63 the content to the caching apparatus 1 at the start time. The join command is here illustrated to be sent to the content source 4, even if this typically is not strictly true; the join command is however sent to the content delivery system.

As described in more detail above, the caching apparatus 1 then sends 64 the content to the recording device at a rate which prevents interfering with higher priority content on the local access line. As explained elsewhere in this document, the content is sent 63 from the content source 4 to the caching apparatus 1 in parallel with the content being sent 64 from the caching apparatus to the recording device.

It is to be noted that while the embodiments disclosed herein mainly disclose television content as being the content being cached, any real-time media content, including pure audio content, is compatible with the inventive ideas presented herein.

The invention has mainly been described above with reference to a few embodiments. However, as is readily appreciated by a person skilled in the art, other embodiments than the ones disclosed above are equally possible within the scope of the invention, as defined by the appended patent claims.

1. A media caching apparatus for caching media content for a plurality of remotely located recording devices, each remotely located recording device being connectable to the media caching apparatus via a respective local access line, the media caching apparatus comprising:
a controller configured to receive cache commands to temporarily store a specified media content for a specified recording device;
a memory configured to temporarily store media content and to store an association between the specified media content and the specified recording device;
a content receiving interface configured to receive the specified media content and store the media content in the memory; and
a content transmitting interface configured to send the specified media content to the specified recording device via the local access line coupled to the specified recording device for storage on the specified recording device, wherein the content transmitting interface prevents affecting delivery of higher priority content on the local access line coupled to the specified recording device.

2. The media caching apparatus according to claim 1, wherein the memory is configured to store a plurality of associations between the specified media content and a plurality of specified recording devices, in response to receiving a plurality of cache commands to temporarily store the specified media content, wherein each cache command specifies a different recording device; and
the content transmitting interface is configured to send the media content to all of the plurality of recording devices.

3. The media caching apparatus according to claim 1, further comprising: a content manager configured to delete the media content from the memory when the media content has been transmitted to all specified recording devices.

4. The media caching apparatus according to claim 1, wherein the content receiving interface is configured to receive the specified media content from television content.

5. The media caching apparatus according to claim 1, wherein the media content comprises video and audio content.

6. The media caching apparatus according to claim 1, wherein the media content comprises audio content.

7. The media caching apparatus according to claim 1, wherein the content transmitting interface is configured to prevent affecting delivery of higher priority content by sending the specified media content at a lower priority than that at which higher priority content is transmitted.

8. The media caching apparatus according to claim 1, wherein the content transmitting interface is configured to prevent affecting delivery of higher priority content by limiting the rate at which the media content is sent according to commands from a resource allocation apparatus.

9. The media caching apparatus according to claim 1, wherein the content transmitting interface is configured to send media content only when the media caching apparatus has received a command from the specified recording device that a data portion of the media content can be sent.

10. A method for caching media in a media caching apparatus for a remotely located recording device, the remotely located recording device being connected to the media caching apparatus via a local access line, the method comprising the steps, performed in the media caching apparatus, of:
receiving a cache command to temporarily store a specified media content for a specified recording device;
storing an association between the specified media content and the specified recording device;
receiving the media content;
storing the media content in a memory; and
sending the media content via a transmission line to the specified recording device for storage on the specified recording device via the local access line coupled to the specified recording device, while preventing affecting delivery of higher priority content on the local access line coupled to the specified recording device.

11. The method according to claim 10, wherein the steps of receiving the media content, storing the media content and sending the media content are performed in parallel.

12. The method according to claim 10, wherein:
the step of receiving a cache command comprises receiving a plurality of cache commands to temporarily store the specified media content, wherein each cache command specifies a different recording device;
the step of storing an association comprises storing a plurality of associations between the specified media content and a plurality of specified recording devices; and
the step of sending the media content comprises sending the media content to all of the plurality of recording devices.

13. The method according to claim 10, further comprising the step of: deleting the media content from the memory when the media content has been transmitted to all specified recording devices.

14. The method according to claim 10, wherein the step of receiving the media content comprises receiving the specified media content from broadcast television content.

15. The method according to claim 10, wherein the media content comprises video and audio content.

16. The method according to claim 10, wherein the step of sending the media content prevents affecting delivery of higher priority content by sending the media content at a lower priority than that at which higher priority content is transmitted.

17. The method according to claim 10, wherein the step of sending the media content prevents affecting delivery of higher priority content by limiting the rate at which the media content is sent according to commands from a resource allocation apparatus.

18. The method according to claim 10, wherein the step of sending the media content only sends media content when a command has been received from the specified recording device that a data portion of the media content can be sent.

19. A computer program for caching media in a media caching apparatus for a remotely located recording device, the remotely located recording device being connected to the media caching apparatus via a local access line, the computer program comprising computer program code which, when run on the media caching apparatus, causes the media caching apparatus to:
receive a cache command to temporarily store a specified media content for a specified recording device;
store an association between the specified media content and the specified recording device;
receive the media content;
store the media content in a memory; and
send the media content via a transmission line to the specified recording device for storage on the specified recording device via the local access line coupled to the specified recording device, while preventing affecting delivery of higher priority content on the local access line coupled to the specified recording device.

20. A computer program product comprising a computer program according to claim 19 and a computer readable means on which the computer program is stored.

21. A media recording device being connectable to a remotely located media caching apparatus via a local access line, the media recording device comprising:
a controller configured to send a cache command to a caching apparatus to temporarily store a specified media content for the recording device;
a memory configured to store media content; and
a content receiving interface configured to receive the specified media content and store the media content in the memory.

22. The media recording device according to claim 21, wherein the media recording device is comprised in a set top box, a television set, a personal computer, a media player or a game console.

23. The media recording device according to claim 21, wherein the controller is configured to send a cache command to the caching apparatus to send a data portion of the media content when the controller determines the local access line to have sufficient free capacity for the data portion.

24. A method, performed in a media recording device connected to a remotely located media caching apparatus via a local access line, the method comprising the steps of:
sending a cache command to a caching apparatus to temporarily store a specified media content for the recording device; and
receiving the specified media content and storing the media content in a memory.

25. The method according to claim 24, wherein the cache commands comprises an identifier of the media recording device and an identifier of the specified media.

26. A computer program for a media recording device connected to a remotely located media caching apparatus via a local access line, the computer program comprising computer program code which, when run on the media recording device, causes the media recording device to:
send a cache command to a caching apparatus to temporarily store a specified media content for the recording device; and
receive the specified media content and storing the media content in a memory.

27. A computer program product comprising a computer program according to claim 26 and a computer readable means on which the computer program is stored.
